(19) United States
(12) Patent Application Publication
(10) Pub. No.: US 2015/0095825 A1
(43) Pub. Date: Apr. 2, 2015

(54) PERSON IMAGE DISPLAY CONTROL APPARATUS, METHOD OF CONTROLLING SAME, AND RECORDING MEDIUM STORING CONTROL PROGRAM THEREFOR

(71) Applicant: FUJIFILM Corporation, Tokyo (JP)

(72) Inventor: Hiroyasu YAMAMOTO, Tokyo (JP)

(21) Appl. No.: 14/444,379

(22) Filed: Jul. 28, 2014

(30) Foreign Application Priority Data
Sep. 30, 2013 (JP) 2013-205846

(51) Int. Cl. G06F 3/0484; G06F 3/0482; G06F 3/0486

(52) U.S. Cl. CPC G06F 3/04842; G06F 3/0486; G06F 3/04845; G06F 3/0482
USPC 715/769; 715/810

(57) ABSTRACT

A multiplicity of person images are classified into groups person by person. Representative thumbnail person images, which are representative of persons represented by person images included in respective ones of person image groups, are decided. The representative thumbnail person images decided are displayed on the display screen of an electronic album generating apparatus. A representative thumbnail person image, which represents a person desired to be pasted in a desired frame of the electronic album, is selected from among the representative thumbnail person images displayed. If a list-display command is applied to the electronic album generating apparatus, person images of the person represented by the selected representative thumbnail person image are displayed in the form of a list. The user can select a person image to be pasted in the electronic album from among the person images displayed in the list.

### CROSS-REFERENCE TO RELATED APPLICATIONS

The present application claims priority under 35 U.S.C. §119 to Japanese Patent Application No. 2013-205846, filed Sep. 30, 2013. Each of the above application is hereby expressly incorporated by reference, in its entirety, into the present application.

### BACKGROUND OF THE INVENTION

1. Field of the Invention

This invention relates to a person image display control apparatus, a method of controlling this apparatus, and a recording medium storing the related control program.

2. Description of the Related Art

As images increase in number, it has become necessary to classify these images. To achieve this, a system in which the classifying operation is performed efficiently to improve the convenience of image management has been considered (Patent Document 1).

Further, in an electronic album generating apparatus, images suitable for an electronic album are found automatically from among a multiplicity of images upon taking into consideration such factors an image brightness. The images found are then pasted into image pasting areas of the electronic album.

Patent Document 1: Japan Patent No. 4220458

With the technique described in Patent Document 1, however, it is difficult for the user to designate person images that include a desired person from among a multiplicity of person images.

### SUMMARY OF THE INVENTION

An object of the present invention is to arrange it so that a user can designate, in a comparatively simple manner, a person image that includes a desired person from among a multiplicity of person images.

According to the present invention, the foregoing object is attained by providing a person image display control apparatus comprising: a representative person image display control device (representative person image display control means) for controlling a display device in such a manner that representative person images, which represent persons included in a multiplicity of person images, are displayed on a display screen; a representative person image selection device (representative person image selection means) for selecting a representative person image, which is to be displayed, from among the representative person images being displayed on the display screen under control exercised by the representative person image display control device; and a person image display control device (person image display control means) for controlling the display device in such a manner that person images, which include the person represented by the representative person image selected by the representative person image selection device, are displayed on the display screen.

The present invention also provides a control method suited to the above-described person image display control apparatus. Specifically, the present invention provides a method of controlling a person image display control apparatus, the method comprising the steps of: a representative person image display control device controlling a display device in such a manner that representative person images, which represent persons included in a multiplicity of person images, are displayed on a display screen; a representative person image selection device selecting a representative person image, which is to be displayed, from among the representative person images being displayed on the display screen under control exercised by the representative person image display control device; and a person image display control device controlling the display device in such a manner that person images, which include the person represented by the representative person image selected by the representative person image selection device, are displayed on the display screen.

The present invention also provides a recording medium storing a program for controlling a person image display control apparatus.

The apparatus may further comprise a person image detection device (person image detection means) for finding person images, which include the person represented by the representative person image selected by the representative person image selection device, from among a multiplicity of person images. In this case, for example, the person image display control device would control the display device in such a manner that the person images found by the person image detection device are displayed on the display screen.

The apparatus may further comprise a first person image grouping device (first person image grouping means) for grouping a multiplicity of person images into a plurality of person image groups per person included in the person images. In this case, for example, the person image display control device would control the display device in such a manner that a person image, which is included in a person image group represented by a representative person image selected by the representative person image selection device, is displayed on the display screen, the person image group being among the person image groups into which the person images have been grouped by the person image grouping device.

The apparatus may further comprise an image pasting area selection device (image pasting area selection means) for selecting an image pasting area, which is for pasting a person image, from among a multiplicity of image pasting areas included in an electronic album; and a person image designation device (person image designation means) for designating a person image, which is to be pasted into the image pasting area selected by the image pasting area selection means, from among person images being displayed on the display screen under control exercised by the person image display control device.

The apparatus may further comprise an electronic album generating device (electronic album generating means) for generating an electronic album by pasting person images, which have been designated by the person image designation device, into image pasting areas selected by the pasting area selection device.

The representative person image display control device, by way of example, controls the display device in such a manner that representative thumbnail person images, which are thumbnail images of representative person images representing persons included in a multiplicity of person images, are displayed on the display screen; the representative person image selection device, by way of example, selects one or a plurality of representative thumbnail person images from among representative thumbnail person images being displayed on the display screen under control exercised by the representative person image display control device; and the person image detection device, by way of example, finds person images, which are represented by one or a plurality of representative thumbnail person images selected by the representative person image selection device, from among a multiplicity of person images.

The apparatus may further comprise a second person image grouping device (second person image grouping means) for grouping a multiplicity of person images into a plurality of person image groups per person included in the person images; and a representative person image decision device (representative person image decision means) for deciding, per person image group into which the person images have been grouped by the second person image grouping device, a representative person image of person images included in the person image group. In this case, for example, the representative person image display control device would control the display device in such a manner that the representative person image decided by the representative person image decision device is displayed on the display screen. The first person image grouping device and the second person image grouping device may be the same device or different devices.

The apparatus may further comprise a person image count calculation device (person image count calculation means) for calculating the number of person images that include a person represented by a representative person image. The representative person image display control device, for example, would display the number of person images, which has been calculated by the person image count calculation device, on the display screen in association with the corresponding representative person image.

The representative person image display control device may control the display device in such a manner that representative person images are displayed on the display screen in order of decreasing number of person images.

The apparatus may further comprise a determination device (determination means) for determining whether a new person image has been applied to the person image display control apparatus. In this case, for example, in response to a determination by the determination device that a new person image has been applied to the person image display control apparatus, the person image count calculation device would re-calculate the numbers of person images represented by representative person images.

The representative person image selection device, by way of example, selects a representative person image indicative of display and a representative person image indicative of non-display from among representative person images being displayed on the display screen under control exercised by the representative image display control device; and the person image detection device, by way of example, finds, from among a multiplicity of images, person images that include a person represented by the representative person image selected by the representative person image selection device as being indicative of display, but that do not include a person represented by the representative person image selected by the representative person image selection device as being indicative of non-display.

The apparatus may further comprise an automatic mode setting device (automatic mode setting means) for setting an automatic mode; and a person image decision device (person image decision means), responsive to setting of the automatic mode by the automatic mode setting device, for deciding upon a person image, which is to be pasted into an image pasting area selected by the image pasting area selection device, from among person images represented by a representative person image selected by the representative person image selection device.

The apparatus may further comprise an image-capture time series grouping device (image-capture time series grouping means) for dividing a multiplicity of person images into a multiplicity of groups in accordance with chronological order of image capture; and a correlation device (correlation means) for correlating the multiplicity of groups, into which the person images have been divided by the image-capture time series grouping device, with pages of an electronic album in such a manner that the older the image-capture time, the earlier the pages with which the groups are correlated. In this case, the person image decision device would decide upon a person image, which is to be pasted into an image pasting area selected by the image pasting area selection device, from among person images that are included in a group correlated with a page on which the image pasting area selected by the image pasting area selection device exists, and that are represented by a representative person image selected by the representative person image selection device.

The person image decision device decides upon person images in such a manner that different person images are pasted into different image pasting areas, by way of example.

The apparatus may further comprise a notification device (notification means) for notifying of the fact that the person image decision device could not make a decision when such is the case.

In accordance with the present invention, representative person images representing persons included in a multiplicity of person images are displayed on a display screen. When a representative person image to be displayed is selected from among the representative person images being displayed, person images that include the person represented by the selected representative person image are displayed on the display screen. When a representative person image representing a desired person is selected, person images that include this person are displayed. It therefore becomes possible to select a desired person image from among displayed person images. In accordance with the present invention, a multiplicity of person images are represented using representative person images, thereby making it easy for the user to specify images. Accordingly, it is considered that a multiplicity of person images is the number of person images that will not fit on one screen, e.g., ten or more person images. Further, in a case where the present invention is applied to an electronic album, the electronic album will be one in which images of four to five people are arrayed on multiple pages such as 24 pages, 36 pages or 48 pages, and in which an average or four or five images will be placed on each page. In this case, therefore, tens to hundreds of person images are considered to constitute the multiplicity of person images (plurality of person images).

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the electrical configuration of an electronic album generating apparatus;

FIG. 2 is a flowchart illustrating processing executed by the electronic album generating apparatus;

FIGS. 3 and 4 are flowcharts illustrating processing executed by the electronic album generating apparatus in a case where a manual mode has been set;

FIG. 5 illustrates the manner in which representative thumbnail person images are generated;

FIGS. 6 to 11 are examples of images displayed on a display screen;

FIGS. 12 and 13 are flowcharts illustrating processing executed by the electronic album generating apparatus in a case where an automatic mode has been set;

FIG. 14 illustrates the relationship between image-capture date and time and number of images captured; and

FIG. 15 is an example of images displayed on a display screen.

### DESCRIPTION OF THE PREFERRED EMBODIMENT

A preferred embodiment of the present invention will be described in detail with reference to the drawings.

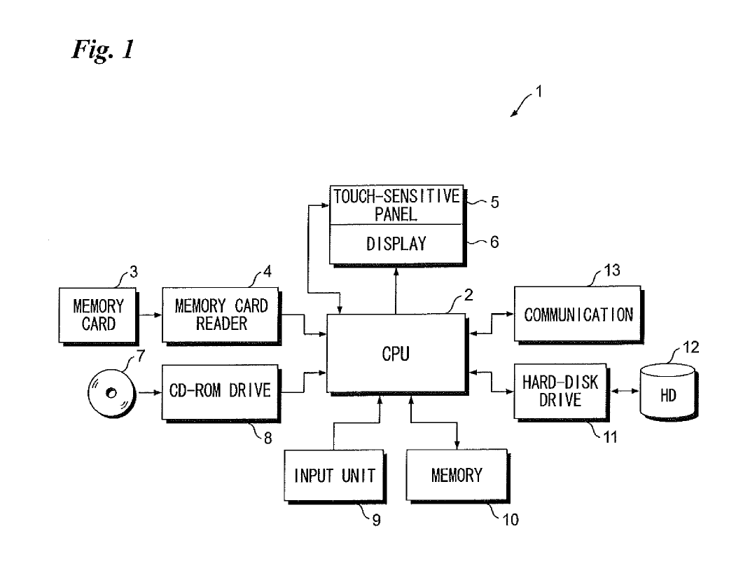

FIG. 1, which illustrates a preferred embodiment of the present invention, is a block diagram illustrating the electrical configuration of an electronic album generating apparatus (person image display control device and person image decision device for an electronic album) 1.

Although the electronic album generating apparatus 1 is installed in a supermarket or convenience store or the like, an electronic album can also be generated by installing an operation program, described below, in a personal computer in the possession of the user.

The overall operation of the electronic album generating apparatus 1 is controlled by a CPU 2.

The electronic album generating apparatus 1 includes a display device 6 having a touch-sensitive panel 5 formed on a display screen. A signal indicating that the touch-sensitive panel 5 has been touched is input to the CPU 2.

The electronic album generating apparatus 1 further includes an input unit 9 inclusive of a keyboard, mouse and the like, and a memory 10 for storing data and the like temporarily. The electronic album generating apparatus 1 further includes a hard disk 12, a hard-disk drive 11 for accessing the hard disk 12, and a communication unit 13 for communicating with a server or the like via the Internet.

When a CD-ROM (compact disk-read-only memory) (recording medium) 7 storing an operation program (described later) is loaded into a CD-ROM drive 8, the operation program that has been stored on the CD-ROM 7 is read and the read operation program is installed in the electronic album generating apparatus 1. It may of course be arranged so that the operation program is downloaded by the communication unit 13 and the downloaded operation program is then installed in the electronic album generating apparatus 1.

If a memory card 3 storing person image files representing a multiplicity of person images (images that include persons) to be pasted in (combined with) an electronic album is loaded in a memory card reader 4, the multiplicity of image files are read from the memory card 3 by the memory card reader 4.

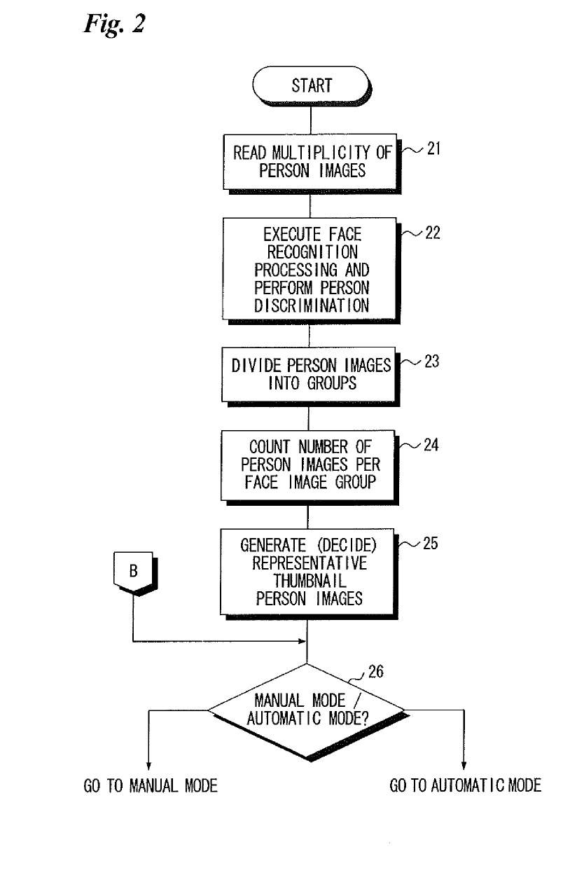

FIG. 2 is a flowchart illustrating part of the processing executed by the electronic album generating apparatus 1.

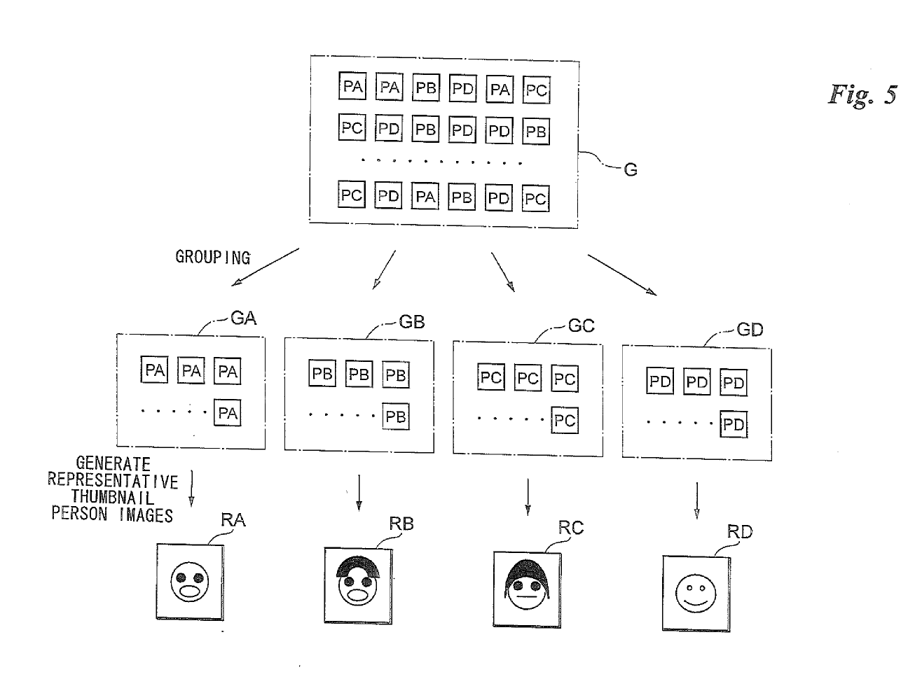

The memory card 3 storing a multiplicity of person image files (the terminology “multiplicity of person image files” generally refers to files representing tens of images or more that will not fit on one screen, these being person images the number of which is considered to be necessary for generating an electronic album) is loaded in the memory card reader 4 by the user. In response, the multiplicity of person image files stored on the memory card 3 are read by the memory card reader 4 and stored temporarily in the memory 10 (step 21). As shown in FIG. 5, a multiplicity of image files representing a multiplicity of person images PA, PB, PC, PD included in an image group G are stored in the memory 10. In this embodiment, PA, PB, PC and PD represent person images that include the persons “Mr. A”, “Mr. B”, “Mr. C” and “Mr. D”, respectively. In each of the person images PA, PB, PC and PD, the image of the respective person alone may appear or the images of persons in addition to the image of the respective person may appear.

Each of the multiplicity of person images represented by the multiplicity of person image files is subjected to person recognition processing by the CPU 2 so that person discrimination is carried out (step 22). By virtue of these processing steps, the persons included in each of the person images are recognized so that it can be ascertained whether a person is identical with or different from another. When this is done, the person images are grouped person by person (step 23).

With reference to FIG. 5, such grouping groups the person images into a person image group GA of person images PA that include “Mr. A”, a person image group GB of person images PB that include “Mr. B”, a person image group GC of person images PC that include “Mr. C”, and a person image group GD of person images PD that include “Mr. D”. (This is the function of first person image grouping means, second person image grouping means and third person image grouping means.)

When the person images are grouped person by person, the number of person images included in each person image group is counted (step 24). For example, the numbers of person images in the respective person image groups are counted with the results being that person image group GA has 243 person images that include “Mr. A”, person image group GB has 211 person images that include “Mr. B”, person image group GC has 167 person images that include “Mr. C”, and person image group GD has 87 person images that include “Mr. D”. (This is the function of person image count calculation means.)

Next, representative thumbnail person images representing the persons of the person images included in the respective person image groups are generated for every person image group (step 25). As shown in FIG. 5, with regard to person image group GA of “Mr. A”, person image group GB of “Mr. B”, person image group GC of “Mr. C” and person image group GD of “Mr. D”, representative thumbnail person images RA, RB, RC and RD, respectively, are generated. These representative thumbnail person images are thumbnail images of person images in which a sole person appears from among the person images included in the respective person image groups. (This is the function of representative person image decision means.) Naturally, these images need not necessarily be thumbnail images and may just as well be the person images per se. Further, a face image may be detected from among the person images and the detected face image or a thumbnail face image thereof may be adopted as the representative thumbnail person image (representative person image).

When this is done, a mode selection screen for selecting either a manual mode or automatic mode is displayed on the display screen of the display device 6 (step 26). (This is the function of manual mode setting means and automatic mode setting means.) The manual mode is a mode in which the user selects person images to be pasted in the electronic album while the user checks the person images. The automatic mode is such that although the user makes the decision with regard to the persons of person images to be pasted in the electronic album, specifically it is the CPU 2 of the electronic album generating apparatus 1 that decides the person images to be pasted in the electronic album. The manual mode will be described first.

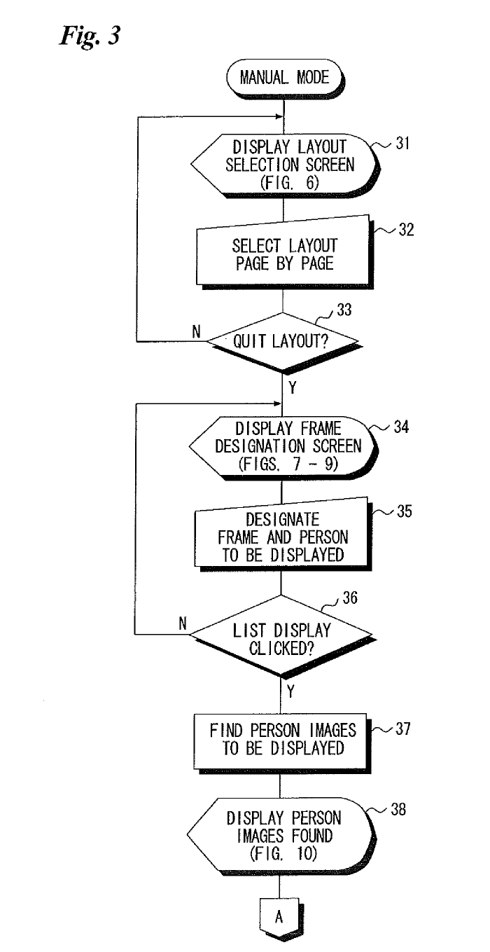

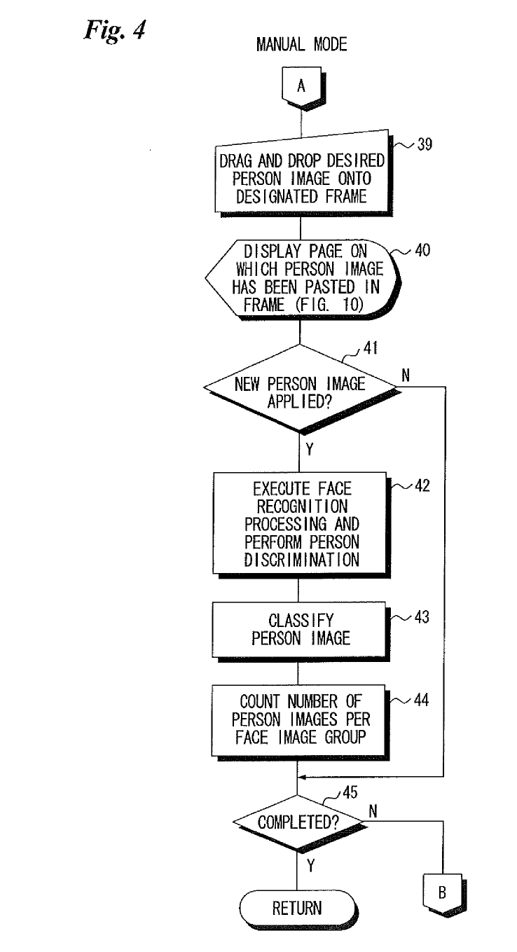

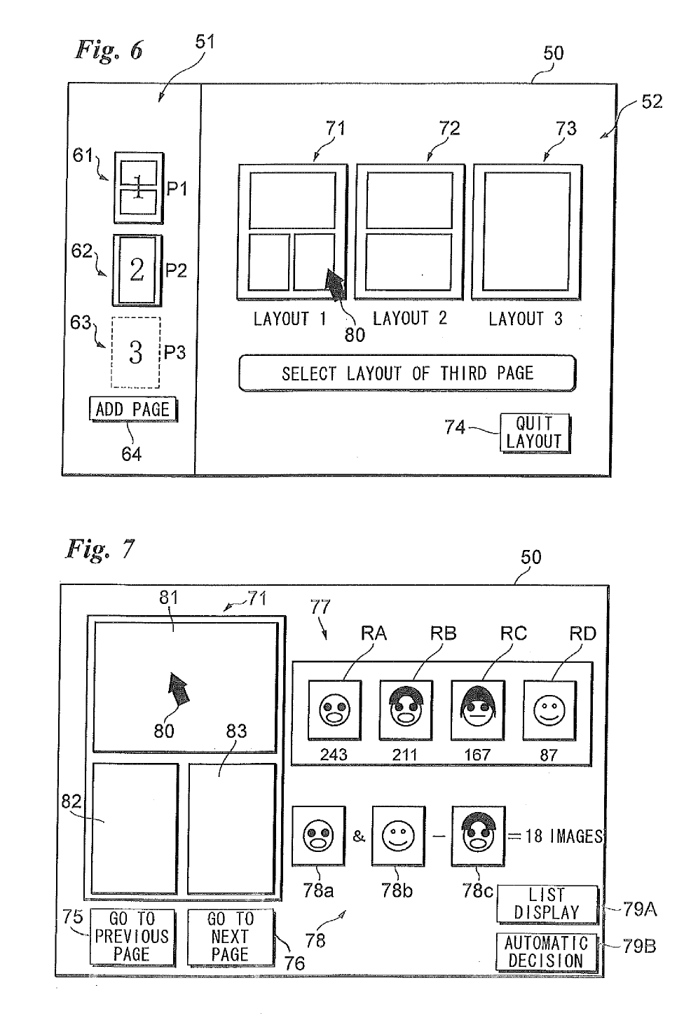

FIGS. 3 and 4 are flowcharts illustrating processing executed by the electronic album generating apparatus 1 in the manual mode. FIGS. 6 to 10 are examples of images displayed on the display screen of the display device 6.

When the manual mode is set by the user, a layout selection screen shown in FIG. 6 is displayed on the display screen of the display device 6 (step 31).

With reference to FIG. 6, a layout display area 52 is formed substantially over the entirety of the layout selection screen displayed on a display screen 50. A plurality of layout images 71, 72 and 73 are being displayed in the layout display area 52. The layout images 71, 72 and 73 indicate examples of layouts of pages that constitute an electronic album. Formed at the lower right of the layout display area 52 is a layout quit command area 74 in which characters reading “QUIT LAYOUT” are being displayed. A page image display area 51 is formed on the left side of the layout selection screen. Page images of the electronic album having the selected layout are displayed in the page image display area 51. A page image 61 of a first page and a page image 62 of a second page are being displayed. A page planning area 63 is indicated by the broken line below the page image 62. Formed below the page images 61, 62 is an add-page command area 64 in which characters reading “ADD PAGE” are being displayed.

When the add-page command area 64 is clicked using a mouse (or when the touch-sensitive panel 5 is tapped), page planning areas are displayed in the page image display area 51 in the order of the pages. For example, initially a page planning area for the first page is displayed in the page image display area 51. If the desired layout image is dragged and dropped onto the page planning area, the layout becomes that of the page indicated by this page planning area (step 32: select layout). When the selection of layout of all pages of the electronic album is finished, the layout quit command area 74 is clicked by the user. Layout selection processing ends as a result (step 33).

A frame designation screen is then displayed on the display screen 50 (step 34). (This is the function of image pasting area selection means.)

FIG. 7 is an example of the frame designation screen.

A layout image (layout image 71 in FIG. 7) for each page constituting the electronic album is displayed on the left side of the frame designation screen. Formed below the layout image are a previous-page display command area 75 bearing characters reading “GO TO PREVIOUS PAGE” and a next-page display command area 76 bearing characters reading “GO TO NEXT PAGE”. If the previous-page display command area 75 is clicked by the user, the layout image of the page preceding the layout image being displayed is displayed on the display screen 50. If the next-page display command area 76 is clicked by the user, the layout image of the page following the layout image being displayed is displayed on the display screen 50. The layout image 71 includes frames (image pasting areas 81, 82 and 83) in which person images will be pasted.

A representative thumbnail person image display area 77 is formed on the right side of the frame designation screen at the upper portion thereof (this is the function of representative person image display control means). The (plurality of) representative thumbnail person images RA, RB, RC and RD generated (decided) in the manner described above are being displayed in the representative thumbnail person image display area 77. The numbers of person images that include the persons represented by the representative thumbnail person images RA, RB, RC and RD are being displayed below and in association with respective ones of the representative thumbnail person images RA, RB, RC and RD. The representative thumbnail person images RA, RB, RC and RD are being displayed on the display screen 50 in order of decreasing number of person images.

Formed on the right side of the frame designation screen at the lower portion thereof is a display-target person image command area 78 for providing the electronic album generating apparatus 1 with a command that causes display of a person image that is to be displayed (this is the function of representative person image selection means). The requirements of a person image that will be pasted in the electronic album are being displayed in the display-target person image command area 78. In the example illustrated in FIG. 7, the area 78 shows an arithmetic expression in which an area 78a and an area 78b are connected by an AND (&) symbol and the area 78b and an area 78c are connected by minus (−) symbol. If a representative thumbnail person image being displayed in the representative thumbnail person image display area 77 is dragged and dropped onto each area of the areas 78a, 78b, 78c (this is the function of person image designation means), then person images that comply with the arithmetic expression will be found by the CPU 2 and the number thereof will be displayed. In the example of FIG. 7, the representative thumbnail person image RA has been dragged and dropped onto the area 78a, the representative thumbnail person image RD has been dragged and dropped onto the area 78b, and the representative thumbnail person image RB has been dragged and dropped onto the area 78c. The system proceeds to find person images that include both the person “Mr. A” represented by the representative thumbnail person image RA and the person “Mr. D” represented by the representative thumbnail person image RD but not the person “Mr. B” represented by the representative thumbnail person image RB (this is the function of person image detection means). The number of person images resulting from this search is being displayed next to the arithmetic expression. (In this example, 18 images have been found.) Formed at the lower right of the frame designation screen is a list-display command area 79A bearing characters reading “LIST DISPLAY”. When the list-display command area 79A is clicked by the user, the person images found based upon the arithmetic expression are displayed on the display screen 50 (this is the function of person image display control means). When the manual mode is in effect, the list-display command area 79A is displayed. When the automatic mode (described later) is in effect, however, an automatic decision command area 79B, which bears characters reading “AUTOMATIC DECISION”, is displayed instead of the list-display command area 79A.

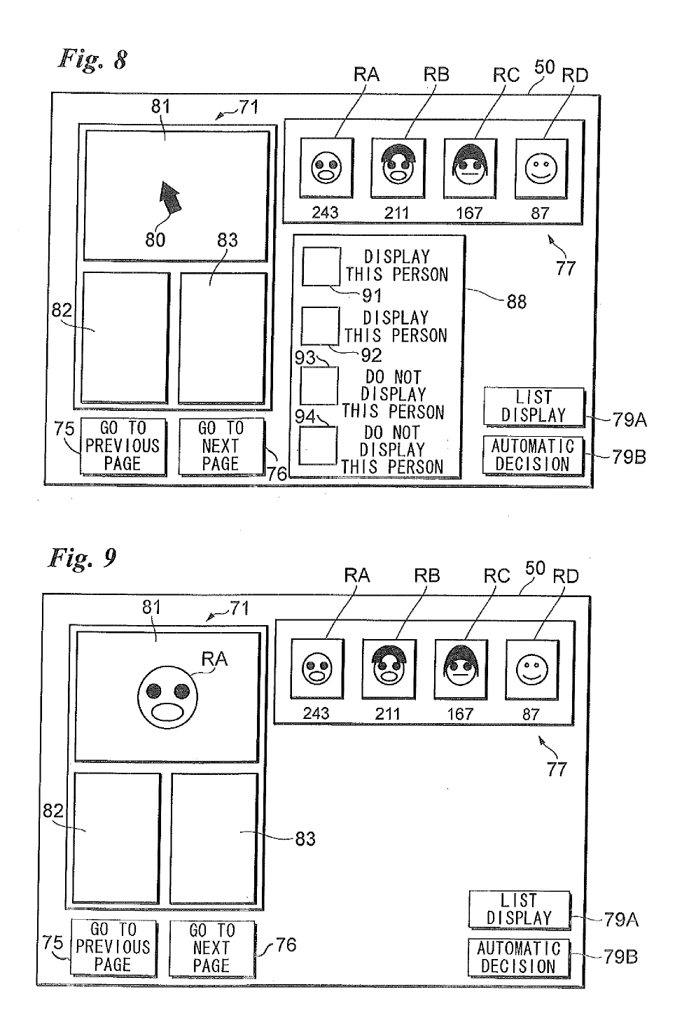

FIG. 8 is another example of the frame designation screen, in which items identical with those shown in FIG. 7 are designated by like reference characters.

Formed on the right side of the frame designation screen at the lower portion thereof is a display-target person image command area 88. Areas 91 to 94 are formed within the area 88. Characters reading “DISPLAY THIS PERSON” follow the areas 91 and 92, and characters reading “DO NOT DISPLAY THIS PERSON” follow the areas 93 and 94. By dragging and dropping representative thumbnail person images onto the areas 91 to 94, person images conforming to the requirement set forth in the display-target person image command area 88 will be displayed on the display screen 50. For example, if we assume that the representative thumbnail person images RA, RB, RC and RD have been dragged and dropped onto the areas 91, 92, 93 and 94, respectively, then the CPU 2 will find person images that include the person “Mr. A” represented by the representative thumbnail person image RA and the person “Mr. B” represented by the representative thumbnail person image RB but that do not include the person “Mr. C” represented by the representative thumbnail person image RC and the person “Mr. D” represented by the representative thumbnail person image RD. The person images thus found are displayed on the display screen 50 by clicking the list-display command area 79A.

FIG. 9 is another example of the frame designation screen, in which items identical with those shown in FIG. 7 are designated by like reference characters.

The frame designation screen shown in FIG. 9 does not have the display-target person image command area. Here a desired representative thumbnail person image from among the representative thumbnail person images RA, RB, RC and RD included in the representative thumbnail person image display area 77 is dragged and dropped onto a desired frame of the layout image 71. If the list-display command area 79A is clicked, the person image of the person represented by the representative thumbnail person image that has been dragged and dropped will be displayed in a list. Representative thumbnail person images dragged and dropped are not limited to a single image; a plurality of representative thumbnail person images may be dragged and dropped. In the case of a plurality of representative thumbnail person images, person images in which all the plurality of persons represented by these plurality of representative thumbnail person images appear will be found and displayed in list form.

Further, a representative thumbnail person image need not necessarily be dragged and dropped. It may be arranged so that after a desired frame or frames is designated by the user, a desired one or plurality of representative thumbnail person images is selected (clicked) from among the representative thumbnail person images being displayed in the representative thumbnail person image display area 77. In this case as well, person images that include the person represented by the selected representative thumbnail person image are found and displayed on the display screen 50 by clicking the list-display command area 79A.

When the frame designation screen is displayed, the desired layout image is caused to be displayed on the display screen 50 by the user. By moving a cursor 80 onto a frame included in the layout image being displayed and then clicking the mouse, the frame in which a person image is to be pasted is designated. In the example shown in FIG. 8 or 9, the cursor 80 has been positioned on frame 81 of the layout image 71. If the mouse is clicked, therefore, a person image will be pasted in the frame 81 by the CPU 2. Further, as mentioned above, desired representative thumbnail person images are dragged and dropped by the user in the display-target person image command area 78 or 88, etc. (step 34). If the list-display command area 79A is clicked (“YES” at step 36), the person images conforming to the requirements designated in the display-target person image command area 78 or 88, etc. are found by the CPU 2 (step 37) and the person images that have been found are displayed on the display screen 50 (step 38).

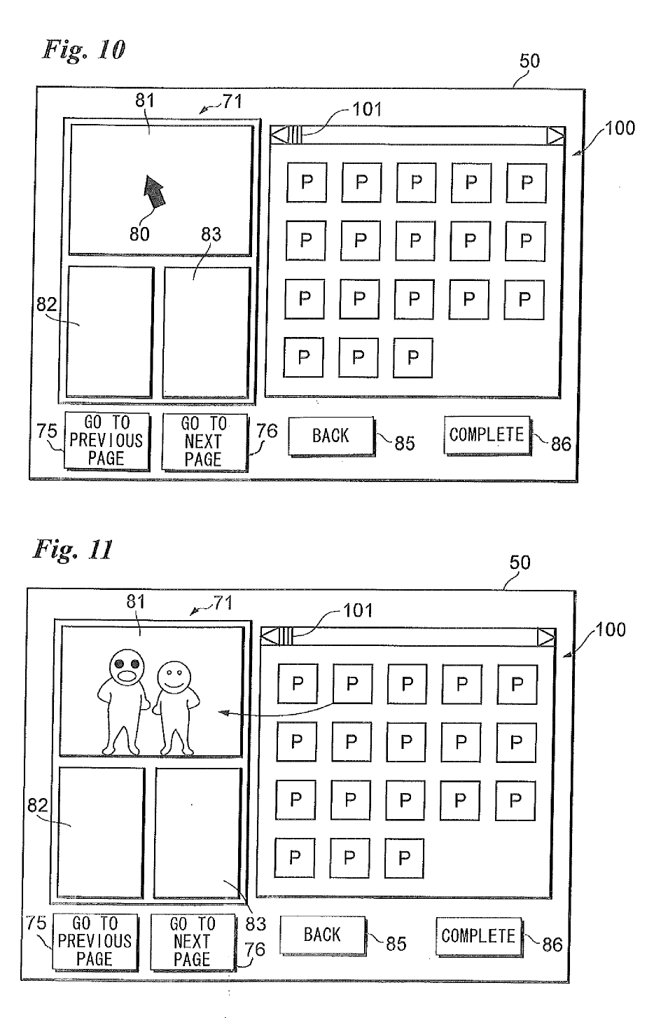

With reference to FIG. 10, a person image list display area 100 appears on the display screen 50 when the list-display command area 79A is clicked. Person images P conforming to the requirements designated in the display-target person image command area 78 or 79, etc. are being displayed in the person image list display area 100. A slide bar 101 is formed above the person image list display area 100. If all of the person images P cannot be displayed in the person image list display area 100, new person images will be displayed in the person image list display area 100 by sliding the slide bar 101.

The user drags and drops a desired person image P, which is from among the person images P being displayed in the person image list display area 100, onto a designated frame (frame 81) (step 39). When this is done, the person image P that has been dragged and dropped is pasted in the designated frame 81 (step 40), as shown in FIG. 11.

Thus, a person image that includes a desired person can be designated by the user from among a multiplicity of person images in comparatively simple fashion.

Formed at the lower right of the display screen are a back-command area 85 bearing characters reading “BACK” and a complete-command area 86 bearing characters reading “COMPLETE”. The immediately preceding screen is restored as a result of the user clicking the back-command area 85. The electronic album is completed as a result of the user clicking the complete-command area 86. (This is the function of electronic album generating means.)

If a new memory card is loaded in the electronic album generating apparatus and a new person image file is read from the memory card (“YES” at step 41) (this is the function of designation means), then the person image represented by the newly read person image file is subjected to face recognition and person discrimination (step 42). The person that has been discriminated is classified so as to fall in any group of the person image groups into which person images have been grouped in the manner described above (step 43). As a result, the number of person images being displayed below the representative thumbnail person image is re-calculated and updated by the CPU 2 (step 44).

In the foregoing embodiment, person images that include a person represented by a representative person image are found. However, since person image groups GA to GD are generated, as described with reference to FIG. 5, it may be arranged so that these person image groups GA to GD are utilized to display person images that include a person represented by a selected representative person image. For example, in a case where the representative thumbnail person images RA to RD are being displayed, as shown in FIG. 7, if the representative thumbnail person image RA is selected and the list-display command area 79A is clicked, the person images included in the person image group GA will be displayed in the person image list display area 100 on the display screen 50. If the representative thumbnail person images RA and RB are selected and the list-display command area 79A is clicked, an AND operation is performed between the person images included in the person image group GA and the person images included in the person image group GB and those person images that are obtained as a result will be displayed in the person image list display area 100. In a case where another representative person image has been selected, a person represented by the selected representative person image can be displayed in a list by utilizing the person image groups GA to GD in a similar manner even in an instance where the combination of selections differs.

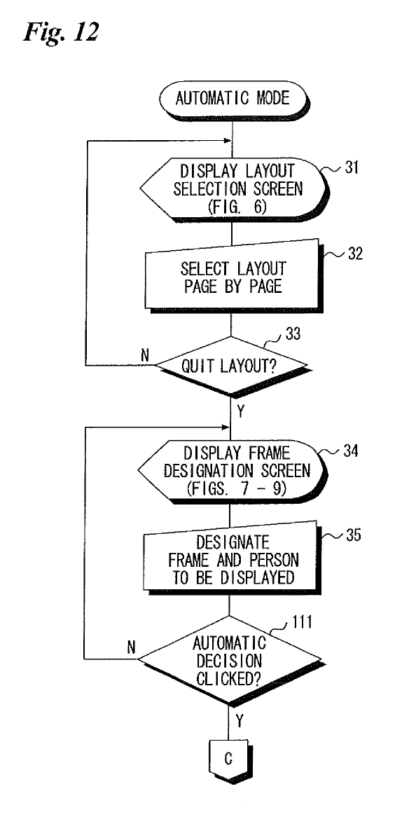

FIGS. 12 to 15 regard processing in a case where the automatic mode has been set.

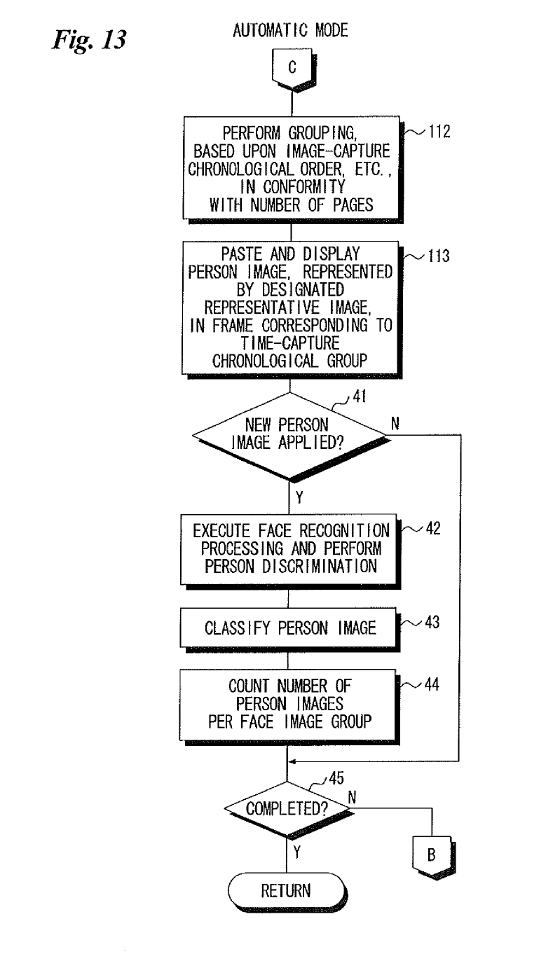

FIGS. 12 and 13 are flowcharts illustrating processing executed by the electronic album generating apparatus 1 in a case where the automatic mode has been set. Processing steps identical with those shown in FIG. 3 or 4 are designated by like step numbers and need not be described again.

In a case also where the automatic mode has been set, the layout selection screen (FIG. 6) is displayed and a layout selection is performed (steps 31 to 33) in a manner similar to that in the case where the manual mode was set. Further, a frame selection screen of the kind shown in FIGS. 7 to 9 is displayed on the display screen 50 and processing such as designation of frames included in the layout image is executed (steps 34, 35).

If the automatic mode has been set, the automatic decision command area 79B is displayed instead of the list-display command area 79A (see FIGS. 7 to 9). If the automatic decision command area 79B is clicked by the user (YES at step 111), a multiplicity of person images are grouped in accordance with an image-capture time series (step 112).

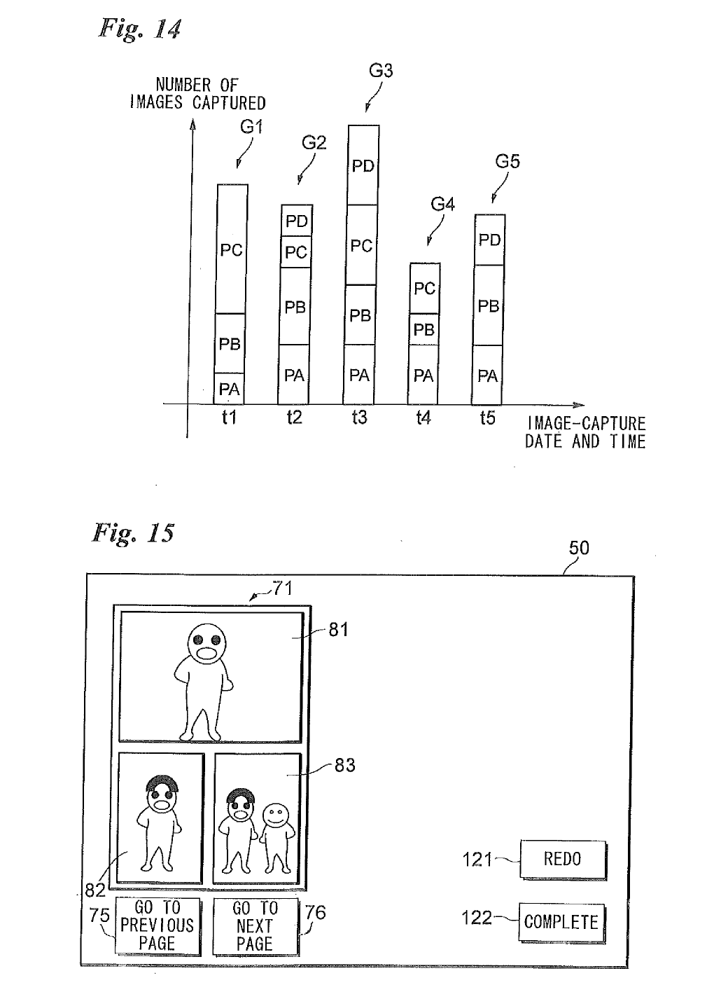

FIG. 14 illustrates the manner in which person images are grouped in accordance with an image-capture time series.

The horizontal axis in FIG. 14 indicates image-capture date and time and the vertical axis the numbers of images captured.

The person images are grouped in accordance with an image-capture time series in such a manner that the number of groups will be the same as the number of pages in the electronic album (step 112). The number of pages in the electronic album is decided in the processing for selecting the layout in the manner described above. In a case where the number of pages in the electronic album has been predetermined, the person images are grouped by the CPU 2 in accordance with the image-capture time series in such a manner that the number of groups will be the same as the number of pages (this is the function of image-capture time series grouping means).

Assume that the number of pages in the electronic album is five. Accordingly, the person images are grouped into five groups G1 to G5 in accordance with the image-capture time series so as to conform to the number of pages. Image-capture dates and times are graphed from newest to oldest in the order t1, t2, t3, t4 and t5. The groups and the pages of the electronic album are correlated in such a manner that the older the image-capture time, the earlier the album pages with which the groups are correlated (this is the function of correlation means). Each of the groups G1 to G5 includes captured images of different persons. For example, if the group is group G1, then group G1 indicates that person images PA, PB and PC are included. The same holds true for the other groups G2 to G5 as well.

When the person images are divided into groups that are in accordance with the image-capture time series, the person image of a person represented by the designated representative image is pasted in a frame of the page that corresponds to the group (step 41). For example, assume that the automatic decision command area 79B has been clicked under the conditions shown in FIG. 7. Further, assume that the layout image 71 is the third page of the electronic album. Since the third page of the electronic album corresponds to the group G3 shown in FIG. 14, person images that conform to the conditions designated in the display-target person image command area 78 are found by the CPU 2 automatically from among the person images included in the group G3. The larger the face of a person included in a person image, the more the evaluation of the person image is raised, the more a person image is blurred or out of focus, the more the evaluation of the person image is lowered, with the person image having the highest evaluation being found (this is the function of person image decision means). The person image thus found is pasted in the designated frame 81 (step 113). A similar operation is performed with regard to the frames 82, 83 and with regard to the frames of other pages. When a person image is pasted in a frame, the number of images corresponding to the pasted person image is decremented among the numbers of images being displayed below the representative thumbnail person images. It goes without saying that the CPU 2 decides person images in such a manner that a person image identical with a person image that has been pasted in a certain frame will not be pasted in a different frame. Further, it may be arranged so that, in a case where there is no person image that conforms to a designated requirement, another person image is pasted and a notification display “NO APPLICABLE PERSON EXISTS” is presented by the CPU 2 (this is the function of notification means).

Thus, person images decided automatically by the CPU 2 are pasted in the frames and an electronic album is generated by the CPU 2 in the manner illustrated in FIG. 15.

As many apparently widely different embodiments of the present invention can be made without departing from the spirit and scope thereof, it is to be understood that the invention is not limited to the specific embodiments thereof except as defined in the appended claims.

What is claimed is:

1. A person image display control apparatus comprising:
a representative person image display control device for controlling a display device in such a manner that representative person images, which represent persons included in a multiplicity of person images, are displayed on a display screen;
a representative person image selection device for selecting a representative person image, which is to be displayed, from among the representative person images being displayed on the display screen under control exercised by said representative person image display control device; and
a person image display control device for controlling the display device in such a manner that person images, which include the person represented by the representative person image selected by said representative person image selection device, are displayed on the display screen.

2. The apparatus according to claim 1, further comprising a person image detection device for finding person images, which include the person represented by the representative person image selected by said representative person image selection device, from among a multiplicity of person images;
wherein said person image display control device controls the display device in such a manner that the person images found by said person image detection device are displayed on the display screen.

3. The apparatus according to claim 1, further comprising a first person image grouping device for grouping a multiplicity of person images into a plurality of person image groups per person included in the person images;
wherein said person image display control device controls the display device in such a manner that a person image, which is included in a person image group represented by a representative person image selected by said representative person image selection device, is displayed on the display screen, the person image group being among the person image groups into which the person images have been grouped by said person image grouping device.

4. The apparatus according to claim 1, further comprising:
an image pasting area selection device for selecting an image pasting area, which is for pasting a person image, from among a multiplicity of image pasting areas included in an electronic album; and
a person image designation device for designating a person image, which is to be pasted into the image pasting area selected by said image pasting area selection means, from among person images being displayed on the display screen under control exercised by said person image display control device.

5. The apparatus according to claim 4, further comprising an electronic album generating device for generating an electronic album by pasting person images, which have been designated by said person image designation device, into image pasting areas selected by said pasting area selection device.

6. The apparatus according to claim 1, wherein said representative person image display control device controls the display device in such a manner that representative thumbnail person images, which are thumbnail images of representative person images representing persons included in a multiplicity of person images, are displayed on the display screen;
said representative person image selection device selects one or a plurality of representative thumbnail person images from among representative thumbnail person images being displayed on the display screen under control exercised by said representative person image display control device; and
said person image detection device finds person images, which are represented by one or a plurality of representative thumbnail person images selected by said representative person image selection device, from among a multiplicity of person images.

7. The apparatus according to claim 1, further comprising:
a second person image grouping device for grouping a multiplicity of person images into a plurality of person image groups per person included in the person images; and
a representative person image decision device for deciding, per person image group into which the person images have been grouped by said second person image grouping device, a representative person image of person images included in the person image group;
wherein said representative person image display control device controls the display device in such a manner that the representative person image decided by said representative person image decision device is displayed on the display screen.

8. The apparatus according to claim 1, further comprising a person image count calculation device for calculating the number of person images that include a person represented by a representative person image;
wherein said representative person image display control device displays the number of person images, which has been calculated by said person image count calculation device, on the display screen in association with the corresponding representative person image.

9. The apparatus according to claim 8, wherein said representative person image display control device controls the display device in such a manner that representative person images are displayed on the display screen in order of decreasing number of person images.

10. The apparatus according to claim 8, further comprising a determination device for determining whether a new person image has been applied to the person image display control apparatus;
wherein in response to a determination by said determination device that a new person image has been applied to the person image display control apparatus, said person image count calculation device re-calculates the numbers of person images represented by representative person images.

11. The apparatus according to claim 1, wherein said representative person image selection device selects a representative person image indicative of display and a representative person image indicative of non-display from among representative person images being displayed on the display screen under control exercised by said representative image display control device;
said person image detection device finds, from among a multiplicity of images, person images that include a person represented by the representative person image selected by said representative person image selection device as being indicative of display, but that do not include a person represented by the representative person image selected by said representative person image selection device as being indicative of non-display.

12. The apparatus according to claim 4, further comprising:
an automatic mode setting device for setting an automatic mode; and
a person image decision device, responsive to setting of the automatic mode by said automatic mode setting device, for deciding upon a person image, which is to be pasted into an image pasting area selected by said image pasting area selection device, from among person images represented by a representative person image selected by said representative person image selection device.

13. The apparatus according to claim 12, further comprising:
an image-capture time series grouping device for dividing a multiplicity of person images into a multiplicity of groups in accordance with chronological order of image capture; and
a correlation device for correlating the multiplicity of groups, into which the person images have been divided by said image-capture time series grouping device, with pages of an electronic album in such a manner that the older the image-capture time, the earlier the pages with which the groups are correlated;
wherein said person image decision device decides upon a person image, which is to be pasted into an image pasting area selected by said image pasting area selection device, from among person images that are included in a group correlated with a page on which the image pasting area selected by said image pasting area selection device exists, and that are represented by a representative person image selected by said representative person image selection device.

14. The apparatus according to claim 12, wherein said person image decision device decides upon person images in such a manner that different person images are pasted into different image pasting areas.

15. The apparatus according to claim 12, further comprising a notification device for notifying of the fact that said person image decision device could not make a decision when such is the case.

16. A method of controlling a person image display control apparatus, the method comprising the steps of:
a representative person image display control device controlling a display device in such a manner that representative person images, which represent persons included in a multiplicity of person images, are displayed on a display screen;
a representative person image selection device selecting a representative person image, which is to be displayed, from among the representative person images being displayed on the display screen under control exercised by the representative person image display control device; and
a person image display control device controlling the display device in such a manner that person images, which include the person represented by the representative person image selected by the representative person image selection device, are displayed on the display screen.

17. A tangible recording medium storing a computer-readable program for controlling a computer of a person image display control apparatus which executes processing that includes:
a step of controlling a display device in such a manner that representative person images, which represent persons included in a multiplicity of person images, are displayed on a display screen;
a step of selecting a representative person image, which is to be displayed, from among the representative person images being displayed on the display screen; and
a step of controlling the display device in such a manner that person images, which include the person represented by the selected representative person image, are displayed on the display screen.
